(19) United States
(12) Patent Application Publication
(10) Pub. No.: US 2009/0279294 A1
(43) Pub. Date: Nov. 12, 2009

(54) LIGHT EMITTING DIODE LUMINAIRE

(75) Inventors: Yuan-Chang Liou, Nantou County (TW); Ching-Miao Lu, Taipei City (TW)

Correspondence Address: J C PATENTS, 4 VENTURE, SUITE 250, IRVINE, CA, 92618, US

(73) Assignee: Ching-Miao Lu, Taipei City (TW)

(21) Appl. No.: 12/118,397

(22) Filed: May 9, 2008

(51) Int. Cl. F21V 29/00

(52) U.S. Cl. 362/235

(57) ABSTRACT

A light emitting diode luminaire includes an installing device, a light emitting diode array, a secondary optical light guide plate, a thermal conduction-dissipation device, and a carrier. The light emitting diode array and the secondary optical light guide plate are disposed on the installing device. The thermal conduction-dissipation device includes a thermal dissipation element and a thermal conduction element. The thermal conduction element has a heat absorption portion and at least one heat dissipation portion. The heat absorption portion is thermally coupled to the light emitting diode array, while the heat dissipation portion extends outward. The installing device is assembled on the carrier, and the light emitting diode array and the second optical light guide plate are assembled on the carrier via the installing device.

### BACKGROUND OF THE INVENTION

1. Field of the Invention

The present invention generally relates to a luminaire, in particular, to a light emitting diode LED) luminaire.

2. Description of Related Art

LEDs are semiconductor devices having advantages of small volume, power-saving, no pollution (mercury free), non-fragile, and so on. Therefore, the LEDs are widely applied in the illumination field, and gradually replace mercury lamps, incandescent lamps, halogen lamps, and other conventional lamps.

The LEDs in operation generate high thermal energy which causes the overheating of the LEDs, thus reducing the brightness of the LED and shortening the lifespan of the LEDs. Particularly, the high power LEDs with the consumptive power over 30 W generate an extremely high thermal energy during operation, and are easily damaged due to overheating. Therefore, the current LED luminaire needs a heat dissipation device to control the temperature thereof during operation, so as to prevent overheating the LEDs.

In the conventional LED luminaire, the housing is generally designed according to the heat dissipation area. In order to effectively control the temperature of the LED and enhance the heat dissipation capability, the material of the housing is mostly metal.

The housing of the conventional LED luminaire is designed in consideration of both the heat dissipation function and the chic appearance. If the housing of the LED luminaire is changed into a different fashion, the original heat dissipation capability of the LED luminaire will be adversely affected, and thus the heat dissipation capability of the LED luminaire will be reduced.

### SUMMARY OF THE INVENTION

Accordingly, the present invention is directed to an LED luminaire, so as to control the temperature of the LEDs during operation.

The present invention is directed to an LED luminaire, which includes an installing device, an LED array, a secondary optical light guide plate, a thermal conduction-dissipation device, and a carrier. The LED array and the secondary optical light guide plate are disposed on the installing device, and the thermal conduction-dissipation device includes at least one thermal dissipation element and at least one thermal conduction element. The thermal conduction element has a heat absorption portion and at least one heat dissipation portion. The heat absorption portion is thermally coupled to the LED array. The heat dissipation portion extends outward, and is thermally coupled to the thermal dissipation element. The installing device and the thermal conduction-dissipation device are assembled on the carrier, and the LED array and the secondary optical light guide plate are assembled on the carrier via the installing device.

The present invention has the thermal conduction-dissipation device, so as to quickly dissipate the thermal energy generated by the LEDs when emitting light. Therefore, even if the lamp housing does not assist the heat dissipation, the present invention can still control the temperature of the LED luminaire through the thermal conduction-dissipation device, and further maintain the brightness of the LEDs.

In order to the make aforementioned and other objects, features and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of an LED luminaire according to an embodiment of the present invention.

FIG. 2 is a schematic view of an arrangement of the LEDs in FIG. 1 on a circuit board.

FIG. 3 is a cross-sectional view of an LED luminaire according to another embodiment of the present invention.

### DESCRIPTION OF THE EMBODIMENTS

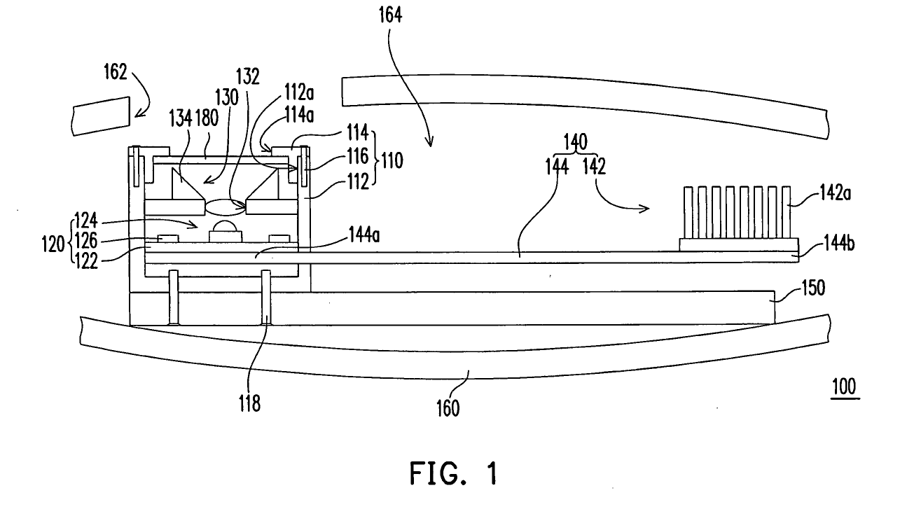

FIG. 1 is a cross-sectional view of an LED luminaire according to an embodiment of the present invention. Referring to FIG. 1, an LED luminaire 100 includes an installing device 110, an LED array 120, a secondary optical light guide plate 130, a thermal conduction-dissipation device 140, and a carrier 150. The LED array 120 and the secondary optical light guide plate 130 are assembled on the installing device 110, and the installing device 110 and the thermal conduction-dissipation device 140 are assembled on the carrier 150. The LED array 120 and the secondary optical light guide plate 130 are assembled on the carrier 150 via the installing device 110.

The thermal conduction-dissipation device 140 includes a thermal dissipation element 142 and a thermal conduction element 144. The thermal conduction element 144 has a heat absorption portion 144a and a heat dissipation portion 144b. The heat absorption portion 144a is thermally coupled to the LED array 120, and the heat dissipation portion 144b extends out of the installing device 110. The thermal dissipation element 142 is, for example, a heatsink including a plurality of heat dissipation fins 142a. The thermal conduction element 144 is, for example, a heat pipe or a metal bar. The material of the metal bar may be a metal having good thermal conduction capability, such as copper, aluminum, or silver.

The way that the heat absorption portion 144a thermally couples to the LED array 120 may be the heat absorption portion 144a directly contacting the LED array 120. Alternatively, the heat absorption portion 144a and the LED array 120 are thermally coupled by indirect thermal contact. In detail, when the heat absorption portion 144a is thermally coupled to the LED array 120 by the indirect thermal contact, a heat dissipation material, for example, a thermal grease or a thermal adhesive, may be disposed between the heat absorption portion 144a and the LED array 120. In addition, the LED array 120 may also be thermally coupled to the heat absorption portion 144a by welding.

When the LED array 120 operates, the thermal energy generated by the LED array 120 can be transferred from the heat absorption portion 144a to the heat dissipation portion 144b, and the heat dissipation portion 144b can transfer the thermal energy to the thermal dissipation element 142. Then, the thermal dissipation element 142 dissipates the thermal energy into the external environment by thermal convection. Hence, the temperature of the LED luminaire 100 is controlled.

Besides, the installing device 110 and the thermal conduction-dissipation device 140 are assembled on the carrier 150 in a non-detachable manner. For example, the installing device 100 is welded on the carrier 150. Certainly, the installing device 110 and the thermal conduction-dissipation device 140 may also be assembled on the carrier 150 in a detachable manner. That is, the installing device 110 and the thermal conduction-dissipation device 140 can be repetitiously assembled on/detached from the carrier 150. During the assembling/detaching process, the overall structure of the installing device 110, the thermal conduction-dissipation device 140, and the carrier 150 will not be damaged substantially.

For example, the installing device 110 is fastened on the carrier 150 by a plurality of screws 118. In this manner, the installing device 110 is assembled on the carrier 150 by fastening the screws 118, and is detached from the carrier 150 by loosening the screws 118. Certainly, the installing device 110 and the thermal conduction-dissipation device 140 can be assembled on the carrier 150 by other manners, which are not limited to the above. For example, in an embodiment (not shown), the installing device 110 may be assembled on the thermal conduction-dissipation device 140 through a buckle.

Therefore, those skilled in the art may detachably assemble the installing device 110 and the thermal conduction-dissipation device 140 on the carrier 150 in any other mechanical manner as required. For example, the installing device 110 and the thermal conduction-dissipation device 140 are clamped with the carrier 150.

The installing device 110 and the thermal conduction-dissipation device 140 are detachably assembled on the carrier 150. That is, the LED luminaire 100 has the advantage of being repetitiously detached and assembled. Thus, when the elements, such as the LED array 120 and the secondary optical light guide plate 130, inside the thermal conduction-dissipation device 140 or the installing device 110, for example have breakdowns, the LED luminaire 100 can be detached for replacement of the above elements.

In the embodiment of FIG. 1, the LED array 120 includes a circuit board 122 and a plurality of LEDs 124 (only one is shown in FIG. 1). A plurality of circuit loop protection elements 126 may be disposed on the circuit board 122 for protecting the circuit loop connected to the LEDs 124, and the protection elements 126 are, for example, Zener diodes.

The thermal energy generated by LED luminaire 100 is quickly dissipated to the external environment via the thermal conduction-dissipation device 140, so the LEDs 124 may be the LEDs with the consumptive power over 60 W. That is, the present invention can adopt the high luminance LEDs with the consumptive power over 60 W.

The material of the installing device 110 may be a metallic material or a non-metallic material, and the non-metallic material is, for example, plastic or ceramic. The plastic is, for example, acrylonitrile butadiene styrene (ABS), i.e. ABS resin. When the material of the installing device 110 is the metallic material, the installing device 110 can quickly transfer the thermal energy generated by the LED luminaire 100 during operation to the thermal conduction-dissipation device 140, and then to the external environment via the thermal conduction-dissipation device 140.

In addition, the installing device 110 may include a lamp case 112. The lamp case 112 has a first light exit port 112a. The LED array 120 and the secondary optical light guide plate 130 are located in the installing device 110, and the secondary optical light guide plate 130 is located at the first light exit port 112a.

The installing device 110 may further include a lampshade 114, and the secondary optical light guide plate 130 is disposed between the lampshade 114 and the LED array 120. The lampshade 114 has a second light exit port 114a. The light emitted by the LED array 120 comes out through the first light exit port 112a and the second light exit port 114a.

In addition, the LED luminaire 100 may further include an optical sheet 180 disposed between the first light exit port 112a and the second light exit port 114a. The optical sheet 180 is, for example, a prism, for providing more uniform light.

In this embodiment, the lampshade 114 is, for example, fastened on the lamp case 112 through a plurality of screws 116. It is noted that the lamp case 112, the lampshade 114, and the secondary optical light guide plate 130 are individual elements, but may also be integrally formed. For example, the lamp case 112 and the lampshade 114 may be integrally formed. Or, the lampshade 114 and the secondary optical light guide plate 130 are integrally formed. Or, the lamp case 112 and the secondary optical light guide plate 130 are integrally formed. Or, the lamp case 112, the lampshade 114, and the secondary optical light guide plate 130 are integrally formed.

The LED luminaire 100 may further include a lamp housing 160. The lamp housing 160 is detachably assembled on the carrier 150. The installing device 110 is located between the lamp housing 160 and the carrier 150. That is, the installing device 110, the LED array 120, the secondary optical light guide plate 130, and the thermal conduction-dissipation device 140 may be installed with the lamp housing 160 via the carrier 150. The lamp housing 160 can give a pleasing appearance and protect the LED luminaire 100, and the lamp housing 160 may have an opening 162 and an accommodation space 164. The LED luminaire 100 is disposed in the accommodation space 164, and is exposed by the opening 162.

It should be noted that the lamp housing 160 is an optional element of the LED luminaire 100. That is, the lamp housing 160 is not an essential element of the LED luminaire 100. Therefore, the LED luminaire 100 of the present invention may not include the lamp housing 160. Moreover, the thermal energy generated by the LED array 120 during operation is dissipated to the external environment via the thermal conduction-dissipation device 140, so that the temperature of the LED luminaire 100 is controlled. Therefore, even if the LED luminaire 100 does not include the lamp housing 160, the temperature of the LED luminaire 100 is still under control.

In addition, the material of the lamp housing 160 may be metal or plastic. The thermal energy generated by the LED array 120 is dissipated to the external environment via the thermal conduction-dissipation device 140. When the material of the lamp housing 160 is plastic or any other material with poor thermal conduction capability, the LEDs 124 may still adopt the high luminance LED with the consumptive power over 60 W. The high luminance LED will not overheat in regardless of the material or the poor heat dissipation capability of the lamp housing 160.

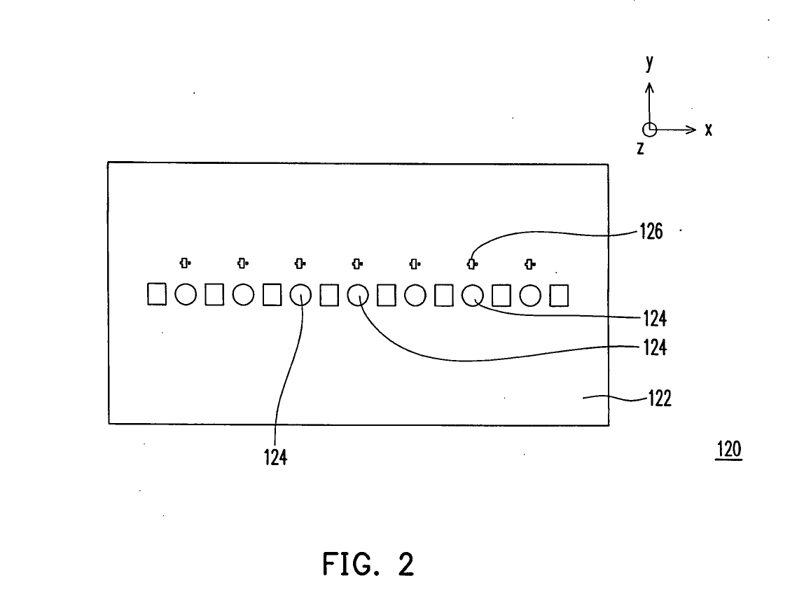

FIG. 2 is a schematic view of an arrangement of the LEDs in FIG. 1 on a circuit board. Referring to FIGS. 1 and 2, in this embodiment, the LEDs 124 are arranged along a first axis x. The secondary optical light guide plate 130 has a plurality of hole slots 132 arranged corresponding to the LEDs 124, and a plurality of light guide fins 134 extending along the first axis x is disposed on two sides of the hole slots 132. The light emitted by the LEDs 124 comes out from the hole slots 132, and then to the outside after being reflected by the light guide fins 134. Besides, the arrangement of the LEDs 124 is irregular or annular.

The design of the light guide fin 134 can be used for controlling the direction of the light emitted by the LEDs 124. Hence, the illumination range and the light form of the LED luminaire 100 can be controlled, so that the LED luminaire 100 is applicable to various different environments. In addition, the secondary optical light guide plate 130 can also be used for uniforming the light emitted by the LEDs 124 and have the anti-glare function, thereby achieving better illumination effect.

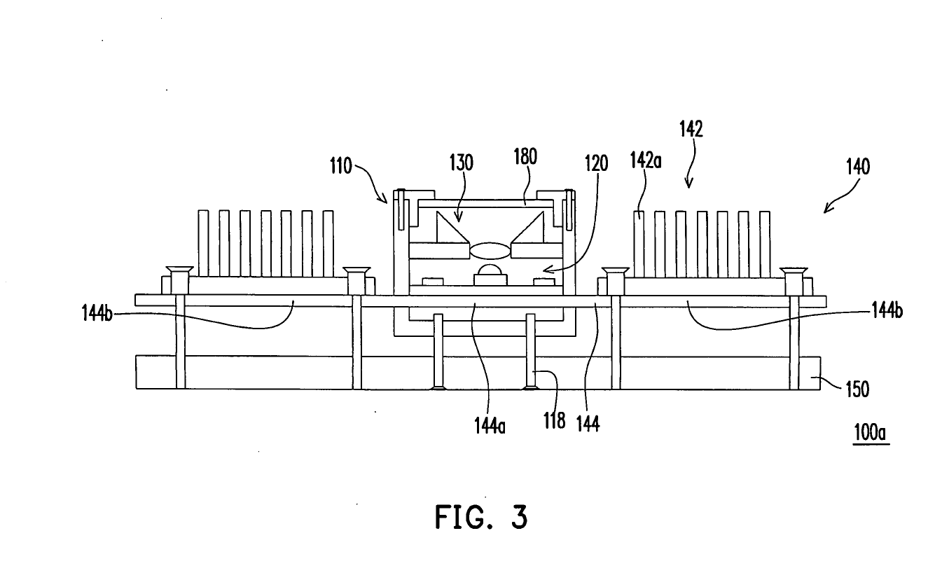

FIG. 3 is a cross-sectional view of an LED luminaire according to another embodiment of the present invention. First, referring to FIG. 3, the thermal conduction-dissipation device 140 of the LED luminaire 100a has a plurality of heat dissipation portions 144b respectively extending towards two sides, and the thermal dissipation elements 142 are thermally coupled to the heat dissipation portions 144b. In addition, similar to the embodiment of FIG. 1, the embodiment of FIG. 2 can also have a lamp housing, and those skilled in the art can implement freely according to the above disclosure, and the details will not be described herein.

To sum up, by the use of the thermal conduction-dissipation device, the present invention can quickly dissipates the thermal energy generated by the LEDs when emitting light, and thus the LED luminaire of the present invention can adopt the high luminance LEDs with the consumptive power over 60 W. Even if the lamp housing is not used for assisting the heat dissipation, the present invention can still make the temperature of the LED luminaire under control through the thermal conduction-dissipation device, so as to prevent the LEDs from overheating. Hence, the present invention maintains the brightness of the LEDs and extends the lifespan of the LEDs.

Next, the thermal energy generated by the LED array is dissipated to the external environment via the thermal conduction-dissipation device, so the entire heat dissipation capability of the LED luminaire of the present invention will not be influenced by the lamp housing. In addition, the lamp housing is detachably assembled on the carrier. Therefore, in the present invention, the LED luminaire can employ various different lamp housings without influencing the entire heat dissipation capability of the LED luminaire.

Further, in the present invention, the LED luminaire can even employ the lamp housing made of the plastic material or any other lamp housing with poor heat dissipation capability, and the brightness of the high luminance LED will not be reduced, or the high luminance LED will not overheat in the situation that heat dissipation capability of the lamp housing is poor.

In addition, the installing device and the thermal conduction-dissipation device are detachably assembled on the carrier. That is, the LED luminaire can be repetitiously detached and installed. Therefore, when the elements inside the thermal conduction-dissipation device or the installing device (for example the LED array and the secondary optical light guide plate) have breakdowns, the LED luminaire of the present invention can be detached for replacement of the above elements. In this manner, in the present invention, the breakdown LED luminaire can be repaired and will not be abandoned. Hence, it can save the cost of purchasing the LED luminaire and decrease the waste of resource meanwhile to meet the current environment protection requirements.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light emitting diode (LED) luminaire, comprising:
an installing device;
an LED array, disposed on the installing device;
a secondary optical light guide plate, disposed on the installing device;
a thermal conduction-dissipation device, comprising:
at least one thermal dissipation element;
at least one thermal conduction element, having a heat absorption portion and at least one heat dissipation portion, wherein the heat absorption portion is thermally coupled to the LED array, and the heat dissipation portion extends outward and is thermally coupled to the thermal dissipation element; and
a carrier, wherein the installing device and the thermal conduction-dissipation device are assembled on the carrier, and the LED array and the secondary optical light guide plate are assembled on the carrier via the installing device.

2. The LED luminaire according to claim 1, wherein a number of the thermal dissipation element is plural, and the thermal dissipation elements are thermally coupled to the heat dissipation portions.

3. The LED luminaire according to claim 1, wherein the thermal conduction element is a heat pipe or a metal bar.

4. The LED luminaire according to claim 1, wherein the thermal dissipation element is a heatsink.

5. The LED luminaire according to claim 1, wherein the installing device and the thermal conduction-dissipation device are detachably assembled on the carrier.

6. The LED luminaire according to claim 1, wherein the installing device is fastened on the carrier by a plurality of screws.

7. The LED luminaire according to claim 1, wherein the installing device is welded on the carrier.

8. The LED luminaire according to claim 1, wherein the material of the carrier is metal.

9. The LED luminaire according to claim 1, further comprising a lamp housing, wherein the lamp housing is detachably assembled on the carrier, and the installing device is located between the lamp housing and the carrier.

10. The LED luminaire according to claim 9, wherein the LED array comprises:
a circuit board; and
at least one LED, disposed on the circuit board, wherein the consumptive power of the LED is more than 60 W, and the material of the lamp housing is plastic.

11. The LED luminaire according to claim 1, wherein the installing device comprises:
a lamp case, having a first light exit port, wherein the LED array and the secondary optical light guide plate are located in the lamp case, and the secondary optical light guide plate is located at the first light exit port.
